(19) United States
(12) Patent Application Publication
(10) Pub. No.: US 2024/0278193 A1
(43) Pub. Date: Aug. 22, 2024

(54) ZEOLITE MEMBRANE COMPLEX AND MEMBRANE REACTOR

(71) Applicant: NGK INSULATORS, LTD., Nagoya-City (JP)

(72) Inventors: Shunsuke KAMATA, Nagoya-City (JP); Kenichi NODA, Nagoya-City (JP); Naoto KINOSHITA, Nagoya-City (JP); Ryotaro YOSHIMURA, Kasugai-City (JP)

(73) Assignee: NGK INSULATORS, LTD., Nagoya-City (JP)

(21) Appl. No.: 18/641,521

(22) Filed: Apr. 22, 2024

Related U.S. Application Data
(63) Continuation of application No. PCT/JP2022/041966, filed on Nov. 10, 2022.

(30) Foreign Application Priority Data
Nov. 12, 2021 (JP) 2021-184980

(51) Int. Cl. B01D 71/02; B01D 67/00; C02F 1/44; C02F 101/34

(52) U.S. Cl. CPC B01D 71/0281; B01D 67/0051; C02F 1/448; C02F 2101/34

(57) ABSTRACT

A zeolite membrane complex includes a porous support and a zeolite membrane formed on the support and containing aluminum, silicon, and carbon. In the zeolite membrane, the molar ratio of carbon to the sum of aluminum and silicon is higher than or equal to 0.1. In the zeolite membrane complex, when a mixed solution having a temperature of 60° C. and containing 50 mass % of water and 50 mass % of ethanol is supplied with a permeate pressure of −94.66 kPaG, the total permeation flux is higher than or equal to 1.0 kg/m² h, and a separation factor of water to ethanol is greater than or equal to 1000.

### CROSS-REFERENCE TO RELATED APPLICATIONS

The present application is a continuation application of International Application No. PCT/JP2022/41966 filed on Nov. 10, 2022, which claims priority to Japanese Patent Application No. 2021-184980 filed on Nov. 12, 2021. The contents of these applications are incorporated herein by reference in their entirety.

### TECHNICAL FIELD

The present invention relates to a zeolite membrane complex and a membrane reactor.

### BACKGROUND ART

Zeolite membrane are conventionally used as separation membranes using a molecular-sieving function. A zeolite membrane is typically formed on a porous support, and a resultant substance is treated as a zeolite membrane complex. For example, Japanese Patent Application Laid-Open No. H7-185275 (Document 1) discloses a separation membrane in which a zeolite membrane having an LTA-type crystal structure (A-type zeolite membrane) is deposited on a porous support, and realizes stable and efficient separation of a mixture such as a water-ethanol mixed solution. “Synthesis and Characterization of A-Type Zeolites” by R. H. JARMAN and other two members, ACS Symposium Series, American Chemical Society, 1983, vol. 218, pp. 267-281) (Document 2) discloses powder synthesis of LTA-type zeolite crystals using tetramethylammonium ions (TMA⁺) as a structure-directing agent.

Like the LTA-type zeolite membrane disclosed in Document 1, a zeolite membrane complex that contains aluminum and silicon and has high water separation performance is commonly likely to have low hydrothermal endurance. There is thus demand for a zeolite membrane complex with high water separation performance and improved hydrothermal endurance.

### SUMMARY OF THE INVENTION

The present invention is intended for a zeolite membrane complex, and it is an object of the present invention to provide a zeolite membrane complex with high water separation performance and improved hydrothermal endurance.

A first aspect of the present invention is a zeolite membrane complex that includes a porous support, and a zeolite membrane formed on the support and containing aluminum, silicon, and carbon. In the zeolite membrane, a molar ratio of carbon to a sum of aluminum and silicon is higher than or equal to 0.1. In the zeolite membrane complex, when a mixed solution having a temperature of 60° C. and containing 50 mass % of water and 50 mass % of ethanol is supplied with a permeate pressure of −94.66 kPaG, a total permeation flux is higher than or equal to 1.0 kg/m² h, and a separation factor of water to ethanol is greater than or equal to 1000.

According to the present invention, it is possible to provide a zeolite membrane complex with high water separation performance and improved hydrothermal endurance.

A second aspect of the present invention is the zeolite membrane complex according to the first aspect, in which in the zeolite membrane, the molar ratio of carbon to the sum of aluminum and silicon is higher than or equal to 0.1 and lower than or equal to 3.0.

A third aspect of the present invention is the zeolite membrane complex according to the first or second aspect, in which in the zeolite membrane, the molar ratio of carbon to the sum of aluminum and silicon is higher than or equal to 0.3 and lower than or equal to 3.0.

A fourth aspect of the present invention is the zeolite membrane complex according to any one of the first to third aspects, in which the zeolite membrane further contains nitrogen.

A fifth aspect of the present invention is the zeolite membrane complex according to any one of the first to fourth aspects, in which the zeolite membrane has a silicon/aluminum molar ratio of higher than or equal to 1 and lower than or equal to 6.

A sixth aspect of the present invention is the zeolite membrane complex according to any one of the first to fifth aspects, in which the zeolite membrane contains an AEI-, AFT-, AFX-, ANA-, CHA-, ETL-, ERI-, FER-, KFI-, LTA-, MER-, RHO-, SOD-, MOR-, FAU-, BEA-, or HEU-type zeolite.

A seventh aspect of the present invention is the zeolite membrane complex according to any one of the first to sixth aspects, in which the zeolite membrane contains an AEI-, AFT-, AFX-, ANA-, CHA-, ETL-, ERI-, KFI-, LTA-, MER-, RHO-, or SOD-type zeolite.

The present invention is also intended for a membrane reactor.

An eighth aspect of the present invention is a membrane reactor that includes the zeolite membrane complex according to any one of the first to sevenths aspects, a catalyst that accelerates a chemical reaction of a starting material, a reactor in which the zeolite membrane complex and the catalyst are placed, and a supplier that supplies the starting material to the reactor. The zeolite membrane complex separates a high-permeability substance having high permeability in a mixture of substances from other substances by allowing the high-permeability substance to permeate the zeolite membrane complex, the mixture of substances containing a product substance generated by a chemical reaction of the starting material in the presence of the catalyst.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is sectional view of a zeolite membrane complex.

FIG. 2 is a sectional view showing part of the zeolite membrane complex in enlarged dimensions.

FIG. 3 is a diagram showing a separation apparatus.

### DETAILED DESCRIPTION

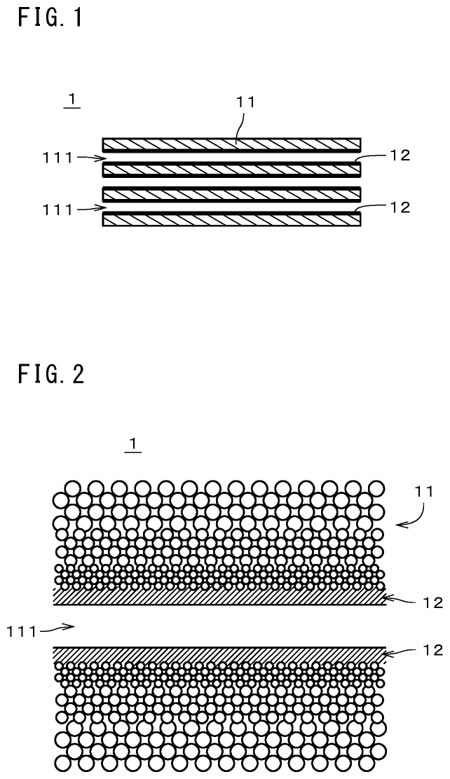

FIG. 1 is a sectional view of a zeolite membrane complex 1. FIG. 2 is a sectional view showing part of the zeolite membrane complex 1 in enlarged dimensions. The zeolite membrane complex 1 includes a porous support 11 and a zeolite membrane 12 formed on the support 11. The zeolite membrane refers to at least a zeolite formed into a membrane on the surface of the support 11 and does not include a membrane formed by simply dispersing zeolite particles in an organic membrane. The zeolite membrane 12 may contain two or more types of zeolites having different structures or compositions. In FIG. 1, the zeolite membrane 12 is illustrated with thick lines. In FIG. 2, the zeolite membrane 12 is hatched. In FIG. 2, the thickness of the zeolite membrane 12 is illustrated greater than the actual thickness.

The support 11 is a porous member that is permeable to gas and liquid. In the example shown in FIG. 1, the support 11 is a monolith support in which a plurality of through holes 111 each extending in the longitudinal direction (i.e., in the right-left direction in FIG. 1) are formed in an integrally-molded column-like body. In the example shown in FIG. 1, the support 11 has an approximately column-like shape. Each through hole 111 (i.e., cell) may have, for example, an approximately circular cross-sectional shape perpendicular to the longitudinal direction. In FIG. 1, the diameter of the through holes 111 is illustrated greater than the actual diameter, and the number of through holes 111 is illustrated smaller than the actual number. The zeolite membrane 12 is formed on the inner surfaces of the through holes 111 and covers approximately the entire inner surfaces of the through holes 111.

The support 11 may have a length (i.e., length in the right-left direction in FIG. 1) of, for example, 10 cm to 200 cm. The outside diameter of the support 11 may be in the range of, for example, 0.5 cm to 30 cm. The distance between the central axes of each pair of adjacent through holes 111 may be in the range of, for example, 0.3 mm to 10 mm. The surface roughness (Ra) of the support 11 may be in the range of, for example, 0.1 μm to 5.0 μm and preferably in the range of 0.2 μm to 2.0 μm. Note that the support 11 may have any other shape such as a honeycomb shape, a flat plate-like shape, a tube-like shape, a cylinder-like shape, a column-like shape, or a prism shape. In the case where the support 11 has a tube- or cylinder-like shape, the thickness of the support 11 may be in the range of, for example, 0.1 mm to 10 mm.

The material for the support 11 may be any of various substances (e.g., ceramic or metal) as long as the substance has chemical stability in the process of forming the zeolite membrane 12 on the surface. In the present embodiment, the support 11 is formed of a ceramic sintered body.

Examples of the ceramic sintered body selected as the material for the support 11 include alumina, silica, mullite, zirconia, titania, yttria, silicon nitride, and silicon carbide. In the present embodiment, the support 11 contains at least one type of substances selected from among the group consisting of alumina, silica, and mullite.

The support 11 may contain an inorganic binding material. The inorganic binding material may, for example, be at least one of titania, mullite, easily sinterable alumina, silica, glass frit, clay minerals, and easily sinterable cordierite.

The support 11 may have a mean pore diameter of, for example, 0.01 μm to 70 μm and preferably 0.05 μm to 25 μm. The mean pore diameter of the support 11 in the vicinity of the surface on which the zeolite membrane 12 is formed may be in the range of 0.01 μm to 1 μm and preferably in the range of 0.05 μm to 0.5 μm. The mean pore diameter may be measured by, for example, a mercury porosimeter, a perm-porometer, or a nano-perm-porometer. Referring to the pore size distribution of the support 11 as a whole including the surface and the interior, D5 may be in the range of, for example, 0.01 μm to 50 μm, D50 may be in the range of, for example, 0.05 μm to 70 μm, and D95 may be in the range of, for example, 0.1 μm to 2000 μm. The porosity of the support 11 in the vicinity of the surface on which the zeolite membrane 12 is formed may be in the range of, for example, 20% to 60%.

For example, the support 11 may have a multilayer structure in which a plurality of layers having different mean pore diameters are laminated one above another in the thickness direction. A mean pore diameter and a sintered particle diameter of a surface layer that includes the surface on which the zeolite membrane 12 is formed are smaller than mean pore diameters and sintered particle diameters of layers other than the surface layer. The mean pore diameter of the surface layer of the support 11 may be in the range of, for example, 0.01 μm to 1 μm and preferably in the range of 0.05 μm to 0.5 μm. In the case where the support 11 has a multilayer structure, the material for each layer may be any of the substances described above. A plurality of layers forming the multilayer structure may be formed of the same material, or may be formed of different materials.

The zeolite membrane 12 is a porous membrane having minute pores (micropores). The zeolite membrane 12 is usable as a separation membrane that separates a specific substance from a mixture of a plurality of types of substances. The zeolite membrane 12 is less permeable to the other substances than to the specific substance. In other words, the permeance of the zeolite membrane 12 to the other substances is lower than the permeance of the zeolite membrane 12 to the aforementioned specific substance.

The zeolite membrane 12 may have a thickness of, for example, 0.05 μm to 30 μm. The thickness of the zeolite membrane 12 may preferable be less than or equal to 10 μm and more preferably less than or equal to 5 μm. Reducing the thickness of the zeolite membrane 12 increases permeance. The thickness of the zeolite membrane 12 may also preferably be greater than or equal to 0.1 μm and more preferably greater than or equal to 0.5 μm. Increasing the thickness of the zeolite membrane 12 improves separation performance. The surface roughness (Ra) of the zeolite membrane 12 may, for example, be less than or equal to 5 μm, preferably less than or equal to 2 μm, more preferably less than or equal to 1 μm, and yet more preferably less than or equal to 0.5 μm.

The zeolite membrane 12 may have a mean pore diameter of, for example, less than or equal to 1 nm. In the case where the maximum number of membered rings of the zeolite constituting the zeolite membrane 12 is n, an arithmetical mean of the minor axis and major axis of the n-membered ring pore is assumed to be a mean pore diameter. An n-membered ring pore refers to a pore that contains n oxygen atoms in a portion where the oxygen atoms form a ring structure by being bonded to T atoms, which will be described later. In the case where the zeolite has a plurality of types of n-membered rings where n is the same number, an arithmetical mean of minor axes and major axes of all of the types of n-membered ring pores is assumed to be a mean pore diameter. In this way, the mean pore diameter of the zeolite membrane is uniquely determined by the framework structure of the zeolite and is obtained from values disclosed in “Database of Zeolite Structures” [online], by International Zeolite Association, Internet <URL:http://www.iza-structure.org/databases/>.

There are no particular limitations on the type of the zeolite constituting the zeolite membrane 12, and the zeolite may, for example, be an AEI-, AFT-, AFX-, ANA-, CHA-, ETL-, ERI-, FER-, KFI-, LTA-, MER-, RHO-, SOD-, MOR-, FAU-, BEA-, or HEU-type zeolite. In a preferable zeolite, the maximum number of membered rings is 8 or less (e.g., 6 or 8), and the zeolite may be of an AEI-, AFT-, AFX-, ANA-, CHA-, ETL-, ERI-, KFI-, LTA-, MER-, RHO-, or SOD-type. The zeolite membrane 12 may be composed of one type of zeolite, or may be composed of two or more types of zeolites. The type of each zeolite can be identified by, for example, X-ray diffraction measurements.

One example of the zeolite constituting the zeolite membrane 12 is an aluminosilicate zeolite in which atoms (T atoms) each located in the center of an oxygen tetrahedron (TO₄) constituting the zeolite are composed of silicon (Si) and aluminum (Al). Silicon and aluminum constitute the framework structure of the zeolite. Some of the T atoms may be replaced by other elements (e.g., Ti, B, or P). By so doing, it is possible to change properties of the zeolite such as adsorption properties.

The silicon/aluminum molar ratio in the zeolite membrane 12 (the value obtained by dividing the number of moles of silicon atoms by the number of moles of aluminum atoms; the same applies below) may preferably be higher than or equal to 1 and lower than or equal to 10 and more preferably higher than or equal to 1 and lower than or equal to 6. This allows the zeolite membrane 12 to have a high affinity for water and improved water separation performance (i.e., dehydration performance). Depending on the type of the zeolite, the silicon/aluminum molar ratio may be lower than or equal to 5, or lower than or equal to 4, or lower than or equal to 3. The silicon/aluminum molar ratio in the zeolite membrane 12 can be adjusted by, for example, adjusting a compounding ratio in a starting material solution, which will be described later (the same applies to the ratio of other elements). The silicon/aluminum molar ratio is measurable by energy dispersed X-ray spectroscopy (EDS) analysis conducted on a section of the zeolite membrane 12. The zeolite membrane 12 may contain alkali metal or alkaline earth metal. The alkali metal may, for example, be sodium (Na), potassium (K), rubidium (Rb), or cesium (Cs). The alkaline earth metal may, for example, be magnesium (Mg), calcium (Ca), or strontium (Sr).

The zeolite membrane 12 may contain any other alkali metal or any other alkaline earth metal. As will be described later, the zeolite membrane 12 is produced using an organic compound called a structure-directing agent (hereinafter, also referred to as an “SDA”). The SDA may, for example, be tetramethylammonium hydroxide. After the formation of the zeolite membrane 12, the zeolite membrane complex 1 is used as a separation membrane without removing the SDA almost or at all. In the zeolite membrane complex 1, the SDA exists in the pores of the zeolite membrane 12, and the zeolite membrane 12 contains carbon (C) that constitutes the SDA. Typically, carbon does not configure the framework structure of the zeolite. The zeolite membrane 12 in which the SDA exists has a stabilized crystal structure and therefore has more improved hydrothermal endurance than zeolite membranes from which the SDA has been removed. As will be described later, hydrothermal endurance can be evaluated from the degree of deterioration in separation performance before and after the zeolite membrane complex 1 is immersed in heated water. Note that the aforementioned zeolite membranes from which the SDA has been removed can be obtained by subjecting the zeolite membrane 12 to heat treatment in an oxidative gas atmosphere and removing the SDA by combustion.

In the zeolite membrane 12 containing the SDA, the molar ratio of carbon to the sum of aluminum and silicon (i.e., a carbon/(aluminum+ silicon) molar ratio; hereinafter, also referred to as the “C/(Al+Si) molar ratio”) is higher than or equal to 0.1 and preferably higher than or equal to 0.3. In this case, the SDA exists in most of the pores in the zeolite membrane 12 and allows more reliable improvement in hydrothermal endurance. The C/(Al+Si) molar ratio may also be, for example, lower than or equal to 5.0, preferably lower than or equal to 4.0, and more preferably lower than or equal to 3.0. Preferably, the SDA contained in the zeolite membrane 12 may not be carbonized or the like and may be in a state containing a large amount of hydrogen (H). In the case where the SDA further contains nitrogen (N), the zeolite membrane 12 also contains nitrogen that constitutes the SDA. Typically, nitrogen also does not constitute the framework structure of the zeolite. As will be described later, the C/(Al+Si) molar ratio is measurable by energy dispersed X-ray spectroscopy (EDS) analysis conducted on a section of the zeolite membrane 12.

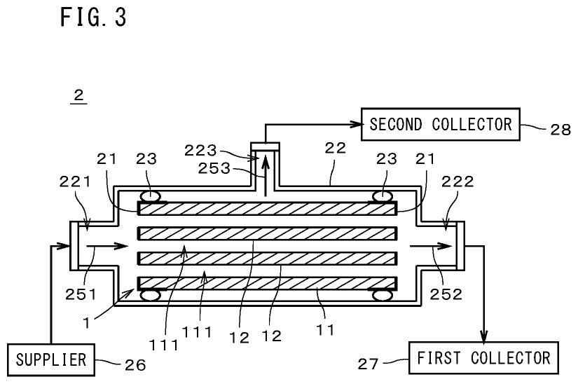

Here, a water/ethanol separation test for the zeolite membrane complex 1 will be described. The water/ethanol separation test may be conducted by, for example, pervaporation using a separation apparatus 2 (see FIG. 3), which will be described later. In the test, a mixed solution having a temperature of 60° C. and containing 50 mass % of water and 50 mass % of ethanol may be supplied to the inside of the through holes 111 of the zeolite membrane complex 1 under atmospheric pressure, for example. The pressure around the outer surface of the support 11 on the permeate side of the zeolite membrane complex 1 is reduced to −94.66 kPaG (approximately 50 Torr). A liquid having high permeability in the mixed solution permeates the zeolite membrane 12 and the support 11 while vaporizing and is then derived from the outer surface of the support 11. The derived gas is cooled and collected as a liquid. The amount of the liquid that has permeated a unit area of the membrane per unit time, i.e., a total permeation flux (kg/m² h), is calculated from the mass of the collected liquid. Moreover, the concentrations (mass %) of water and ethanol in the liquid are measured, and a value obtained by dividing the water concentration by the ethanol concentration (water concentration/ethanol concentration) is acquired as a separation factor.

In the zeolite membrane complex 1, the total permeation flux in the above-described water/ethanol separation test is higher than or equal to 1.0 kg/m² h, and the separation factor of water to ethanol is greater than or equal to 1000. Although the reason why a high total permeation flux and a high separation factor are obtained for the zeolite membrane 12 whose pores are blocked by the SDA is not clear, it is conceivable that the separation is made possible by using clearance of an appropriate size formed between zeolite crystals (at crystal grain boundaries). That is, it is supposed that a high total permeation flux and a high separation factor are achieved as a result of water, which is more adsorbable on the zeolite than ethanol, preferentially occupying and permeating the adjusted clearance between zeolite crystals.

In the evaluation of the hydrothermal endurance, the zeolite membrane complex is immersed in water (here, deionized water) having a temperature of 100° C. for 6 hours and then dried at 80° C. for 12 hours or more. Thereafter, the above-described water/ethanol separation test is conducted again to measure the separation factor. The ratio of the separation factor after immersion to the separation factor before immersion (i.e., separation factor after water immersion/separation factor before water immersion) is obtained as an indicator of the hydrothermal endurance. As described previously, the zeolite membrane 12 in which the SDA exists has more improved hydrothermal endurance than zeolite membranes from which the SDA has been removed by combustion.

Next, one example of the procedure for the production of the zeolite membrane complex 1 will be described. Here, the zeolite membrane 12 is assumed to be formed of an LTA-type zeolite, but the same applies to the case of forming any other type of zeolite membrane. In the production of the zeolite membrane complex 1, firstly, seed crystals that are used to produce the zeolite membrane 12 are prepared. For example, the seed crystals may be acquired from LTA-type zeolite powder that is generated by hydrothermal synthesis. It is preferable that a starting material solution for seed crystals, which is used for hydrothermal synthesis, may contain an SDA, and zeolite powder may be used without removing the SDA therefrom. Alternatively, the starting material solution for seed crystals may not contain an SDA, or an SDA may be removed from zeolite powder. The zeolite powder may be used as-is as seed crystals, or the zeolite powder may be processed by, for example, pulverization to acquire seed crystals.

Then, the porous support 11 is immersed in dispersion liquid in which the seed crystals are dispersed, so that the seed crystals are deposited on the support 11. Alternatively, the seed crystals may be deposited on the support 11 by bringing dispersion liquid in which the seed crystals are dispersed into contact with a portion of the support 11 on which the zeolite membrane 12 is desired to be formed. In this way, a seed-crystal-deposited support is prepared. The seed crystals may be deposited on the support 11 by any other technique.

The support 11 with the seed crystals deposited thereon is immersed in a starting material solution. The starting material solution may be prepared by, for example, dissolving and dispersing an Si source, an Al source, an SDA, and so on in a solvent. The Si source may, for example, be colloidal silica, fumed silica, tetraethoxysilane, or sodium silicate. The Al source may, for example, be sodium aluminate, aluminum isopropoxide, aluminum hydroxide, boehmite, sodium aluminate, or alumina sol. The SDA is an organic compound and may, for example, be tetramethylammonium hydroxide, tetramethylammonium chloride, tetramethylammonium bromide, diethyldimethylammonium hydroxide, tetraethylammonium hydroxide, tetrapropylammonium hydroxide, N,N,N-trimethyl-1-adamantylammonium hydroxide, or 18-crown-6-ether. The solvent in the starting material solution may, for example, be water or alcohol such as ethanol. The starting material solution may further contain an Na source. The Na source may, for example, be sodium hydroxide, sodium aluminate, sodium chloride, or sodium silicate. The starting material solution may be mixed with any other material such as cesium hydroxide.

In the starting material solution, if it is assumed that all Si sources exist as SiO₂ and all Al sources exist as Al₂O₃, the SiO₂/Al₂O₃ molar ratio may preferably be in the range of 4 to 15. The SDA/Al₂O₃ molar ratio may preferably be in the range of 1 to 15. The H₂O/Al₂O₃ molar ratio may preferably in the range of 200 to 2000. If it is assumed that all Na sources exist as Na₂O, the H₂O/Na₂O molar ratio may preferably be in the range of 200 to 1200, and the Na₂O/SiO₂ molar ratio may preferably be in the range of 0.1 to 1.0. In the case where the starting material solution contains cesium hydroxide (CsOH), the CsOH/Al₂O₃ molar ratio may preferably be in the range of 0.1 to 2.0.

Then, the LTA-type zeolite is grown by hydrothermal synthesis using the seed crystals as nuclei so as to form the LTA-type zeolite membrane 12 on the support 11. The temperature at the time of hydrothermal synthesis may be in the range of, for example, 70 to 250° C. The hydrothermal synthesis time may be in the range of, for example, 5 to 200 hours.

When the hydrothermal synthesis is completed, the support 11 and the zeolite membrane 12 are cleaned with deionized water. After the cleaning, the support 11 and the zeolite membrane 12 are dried at, for example, 80° C. Accordingly, the aforementioned zeolite membrane complex 1 is obtained. As described previously, in the production of the zeolite membrane complex 1, the SDA contained in the zeolite membrane 12 is not removed so much or at all. In other words, the processing for removing the SDA is omitted, and the zeolite membrane complex 1 can be produced in a short time.

Next, the separation of a mixture of substances using the zeolite membrane complex 1 will be described with reference to FIG. 3. FIG. 3 is a diagram showing a separation apparatus 2.

The separation apparatus 2 supplies a mixture of substances including a plurality of types of fluid (i.e., gas or liquid) to the zeolite membrane complex 1 and separates a substance having high permeability (hereinafter, also referred to as a “high-permeability substance) in the mixture of substances from the mixture of substances by causing the high-permeability substance to permeate the zeolite membrane complex 1. The separation by the separation apparatus 2 may be conducted, for example, for the purpose of extracting a high-permeability substance from the mixture of substances or for the purpose of condensing a substance having low permeability (hereinafter, also referred to as a “low-permeability substance”).

The mixture of substances (i.e., a fluid mixture) may be a mixed gas that includes a plurality of types of gas, or a mixed solution that includes a plurality of types of liquid, or a gas-liquid two-phase fluid that includes both gas and liquid.

For example, the mixture of substances may contain one or more types of substances selected from among the group consisting of hydrogen (H₂), helium (He), nitrogen (N₂), oxygen (O₂), water (H₂O), carbon monoxide (CO), carbon dioxide (CO₂), nitrogen oxides, ammonia (NH₃), sulfur oxides, hydrogen sulfide (H₂S), sulfur fluorides, mercury (Hg), arsine (AsH₃), hydrogen cyanide (HCN), carbonyl sulfide (COS), C1 to C8 hydrocarbons, organic acid, alcohol, mercaptans, ester, ether, ketone, and aldehyde. The aforementioned high-permeability substance may, for example, be one or more types of substances selected from among the group consisting of H₂, He, N₂, O₂, CO₂, NH₃, and H₂O, and may preferably be H₂O.

Nitrogen oxides are compounds of nitrogen and oxygen. For example, the aforementioned nitrogen oxides may be gas called NOx such as nitrogen monoxide (NO), nitrogen dioxide (NO₂), nitrous oxide (also referred to as dinitrogen monoxide) (N₂O), dinitrogen trioxide (N₂O₃), dinitrogen tetroxide (N₂O₄), or dinitrogen pentoxide (N₂O₅).

Sulfur oxides are compounds of sulfur and oxygen. For example, the aforementioned sulfur oxides may be gas called SOₓ such as sulfur dioxide (SO₂) or sulfur trioxide (SO₃).

Sulfur fluorides are compounds of fluorine and sulfur. For example, the aforementioned sulfur fluorides may be disulfur difluoride (F—S—S—F, S═SF₂), sulfur difluoride (SF₂), sulfur tetrafluoride (SF₄), sulfur hexafluoride (SF₆), or disulfur decafluoride (S₂F₁₀).

C1 to C8 hydrocarbons are hydrocarbons that contain one or more and eight or less carbon atoms. C3 to C8 hydrocarbons each may be any of a linear-chain compound, a side-chain compound, and a cyclic compound. C2 to C8 hydrocarbons each may be either a saturated hydrocarbon (i.e., where double bonds and triple bonds are not located in molecules) or an unsaturated hydrocarbon (i.e., where double bonds and/or triple bonds are located in molecules). C1 to C4 hydrocarbons may, for example, be methane (CH₄), ethane (C₂H₆), ethylene (C₂H₄), propane (C₃H₈), propylene (C₃H₆), normal butane (CH₃(CH₂)₂CH₃), isobutene (CH(CH₃)₃), 1-butene (CH₂═CHCH₂CH₃), 2-butene (CH₃CH═CHCH₃), or isobutene (CH₂—C(CH₃)₂).

The aforementioned organic acid may, for example, be carboxylic acid or sulfonic acid. The carboxylic acid may, for example, be formic acid (CH₂O₂), acetic acid (C₂H₄O₂), oxalic acid (C₂H₂O₄), acrylic acid (C₃H₄O₂), or benzoic acid (C₆H₅COOH). The sulfonic acid may, for example, be ethane sulfonic acid (C2H₆O₃S). The organic acid may be a chain compound, or may be a cyclic compound.

The aforementioned alcohol may, for example, be methanol (CH₃OH), ethanol (C₂H₅OH), isopropanol (2-propanol) (CH₃CH(OH)CH₃), ethylene glycol (CH₂(OH)CH₂(OH)), or butanol (C₄H₉OH).

Mercaptans are organic compounds with hydrogenated sulfur (SH) at the terminal and also are substances called thiol or thioalcohol. The aforementioned mercaptans may, for example, be methyl mercaptan (CH₃SH), ethyl mercaptan (C2H₅SH), or 1-propane thiol (C₃H₇SH).

The aforementioned ester may, for example, be formic acid ester or acetic acid ester.

The aforementioned ether may, for example, be dimethyl ether ((CH₃)₂O), methyl ethyl ether (C₂H₅OCH₃), diethyl ether ((C₂H₅)₂O), or tetrahydrofuran ((CH₂)₄O).

The aforementioned ketone may, for example, be acetone ((CH₃)₂CO), methyl ethyl ketone (C₂H₅COCH₃), or diethyl ketone ((C₂H₅)₂CO).

The aforementioned aldehyde may, for example, be acetaldehyde (CH₃CHO), propionaldehyde (C₂H₅CHO), or butanal (butyraldehyde) (C₃H₇CHO).

The following description is given on the assumption that a mixture of substances to be separated by the separation apparatus 2 is a mixed solution that contains a plurality of types of liquid, and the separation is conducted by pervaporation.

The separation apparatus 2 includes the zeolite membrane complex 1, sealers 21, a housing 22, two seal members 23, a supplier 26, a first collector 27, and a second collector 28. The zeolite membrane complex 1, the sealers 21, and the seal members 23 are placed in the housing 22. The supplier 26, the first collector 27, and the second collector 28 are arranged outside the housing 22 and connected to the housing 22.

The sealers 21 are members that are attached to both ends of the support 11 in the longitudinal direction (i.e., the left-right direction in FIG. 3) and cover and seal both end faces of the support 11 in the longitudinal direction and the outer surface in the vicinity of the both end faces. The sealers 21 prevent an inflow and outflow of liquid from the both end faces of the support 11. For example, the sealer 21 may be a plate-like member made of glass or resin. The material and shape of the sealer 21 may be changed as appropriate. Note that the sealer 21 has a plurality of openings that overlap the plurality of through holes 111 of the support 11, so that both ends of the through holes 111 of the support 11 in the longitudinal direction are not covered with the sealers 21. This allows the inflow and outflow of fluid or the like from the both ends into and out of the through holes 111.

There are no particular limitations on the shape of the housing 22, and for example, the housing 22 may be an approximately cylinder-like tubular member. For example, the housing 22 may be formed of stainless steel or carbon steel. The longitudinal direction of the housing 22 is approximately parallel to the longitudinal direction of the zeolite membrane complex 1. One end of the housing 22 in the longitudinal direction (i.e., the end on the left side in FIG. 3) is provided with a supply port 221, and the other end thereof is provided with a first exhaust port 222. The side face of the housing 22 is provided with a second exhaust port 223. The supply port 221 is connected to the supplier 26. The first exhaust port 222 is connected to the first collector 27. The second exhaust port 223 is connected to the second collector 28. The internal space of the housing 22 is an enclosed space isolated from the space around the housing 22.

The two seal members 23 are arranged around the entire circumference between the outer surface of the zeolite membrane complex 1 and the inner surface of the housing 22 in the vicinity of the both ends of the zeolite membrane complex 1 in the longitudinal direction. Each seal member 23 is an approximately ring-shaped member formed of a material that is impermeable to liquid. For example, the seal members 23 may be O-rings formed of resin having flexibility. The seal members 23 are in tight contact with the outer surface of the zeolite membrane complex 1 and the inner surface of the housing 22 along the entire circumference. In the example shown in FIG. 3, the seal members 23 are in tight contact with the outer surfaces of the sealers 21 and are in indirect tight contact with the outer surface of the zeolite membrane complex 1 via the sealers 21. The space between the seal members 23 and the outer surface of the zeolite membrane complex 1 and the space between the seal members 23 and the inner surface of the housing 22 are sealed so as to almost or completely disable the passage of liquid.

The supplier 26 supplies a mixed solution to the internal space of the housing 22 via the supply port 221. For example, the supplier 26 may include a pump that sends the mixed solution toward the housing 22 under pressure. The pump includes a temperature controller and a pressure regulator that respectively adjust the temperature and pressure of the mixed solution supplied to the housing 22. For example, the first collector 27 may include a reservoir that stores a liquid derived from the housing 22, or a pump that transfers the liquid. The second collector 28 may include, for example, a vacuum pump that reduces the pressure in the space outside the outer surface of the zeolite membrane complex 1 in the housing 22 (i.e., the space sandwiched between the two seal members 23), and a cooling chiller trap that cools and liquefies the gas that has permeated the zeolite membrane complex 1 while vaporizing.

In the separation of the mixed solution, the above-described separation apparatus 2 is prepared for the preparation of the zeolite membrane complex 1. Then, the supplier 26 supplies, to the internal space of the housing 22, a mixed solution that includes a plurality of types of liquid each having different permeability through the zeolite membrane 12. For example, the mixed solution may be composed predominantly of water (H₂O) and ethanol (C₂H₅OH). The mixed solution may further contain liquid other than water and ethanol. The pressure of the mixed solution supplied from the supplier 26 to the internal space of the housing 22 (i.e., feed pressure) may be in the range of, for example, 0.1 MPa to 2 MPa, and the temperature of the mixed solution may be in the range of, for example, 10° C. to 200° C.

The mixed solution supplied from the supplier 26 to the housing 22 is fed from the left end of the zeolite membrane complex 1 in the drawing into each through hole 111 of the support 11 as indicated by an arrow 251. A high-permeability substance that is a liquid with high permeability in the mixed solution permeates the zeolite membrane 12 formed on the inner surface of each through hole 111 and then through the support 11 while evaporating, and is then derived from the outer surface of the support 11. Accordingly, the high-permeability substance (e.g., water) is separated from a low-permeability substance (e.g., ethanol) that is a liquid with low permeability in the mixed solution.

The gas derived from the outer surface of the support 11 (hereinafter, referred to as a “permeate substance”) is guided via the second exhaust port 223 to the second collector 28 as indicated by an arrow 253 and is then cooled and collected as a liquid in the second collector 28. The pressure of the gas collected by the second collector 28 via the second exhaust port 223 (i.e., permeate pressure) may, for example, be approximately 6.67 kPa (approximately 50 Torr). The permeate substance may further include a low-permeability substance that has permeated the zeolite membrane 12, in addition to the aforementioned high-permeability substance.

In the mixed solution, a liquid (hereinafter, referred to as a “non-permeate substance”) other than the substances that have permeated the zeolite membrane 12 and the support 11 passes through each through hole 111 of the support 11 from the left side to the right side in the drawing and is collected by the first collector 27 via the first exhaust port 222 as indicated by an arrow 252. The pressure of the liquid collected by the first collector 27 via the first exhaust port 222 may, for example, be approximately the same as the feed pressure. The non-permeate substance may further include a high-permeability substance that has not permeated the zeolite membrane 12, in addition to the aforementioned low-permeability substance. For example, the non-permeate substance collected by the first collector 27 may be circulated to the supplier 26 and supplied again to the inside of the housing 22.

For example, the separation apparatus 2 shown in FIG. 3 may be used as a membrane reactor. In this case, the housing 22 is used as a reactor. Inside the housing 22, a catalyst is placed that accelerates chemical reactions of starting materials supplied from the supplier 26. For example, the catalyst may be arranged between the supply port 221 and the first exhaust port 222. Preferably, the catalyst may be arranged in the vicinity of the zeolite membrane 12 of the zeolite membrane complex 1. The catalyst to be used is made of an adequate material and has an adequate shape depending on the types of the starting materials and the types of chemical reactions caused by the starting materials. The starting materials include one or two or more types of substances. In order to accelerate the chemical reactions of the starting materials, the membrane reactor may further include a heater for heating the reactor (i.e., housing 22) and the starting materials.

In the separation apparatus 2 used as a membrane reactor, a mixture of substances that include a product substance produced by chemical reactions of the starting materials in the presence of the catalyst is supplied to the zeolite membrane 12 in the same manner as described above, and a high-permeability substance in the mixture of substances is separated from other substances having lower permeability than the high-permeability substance as a result of permeating the zeolite membrane 12. For example, the mixture of substances may be fluid that includes the product substance and an unreacted starting material. Alternatively, the mixture of substances may include two or more types of product substances. The high-permeability substance may be a product substance produced from a starting material, or may be a substance other than a product substance. Preferably, the high-permeability substance may include one or more types of product substances.

In the case where the high-permeability substance is a product substance produced from a starting material, the yield of the product substance can be improved by separating the product substance from the other substances by using the zeolite membrane 12. In the case where the mixture of substances includes two or more types of product substances, the two or more types of product substances may be high-permeability substances, or some of the two or more types of product substances may be high-permeability substances.

Next, zeolite membrane complexes according to Examples 1 to 7 and Comparative Examples 1 to 4 will be described. Table 1 shows the type of the zeolite membrane, the composition of the starting material solution used to form the zeolite membrane, the synthesis temperature, the synthesis time, the firing temperature, and the firing time in Examples 1 to 7 and Comparative Examples 1 to 4. In Examples 1 and 3 to 5 and Comparative Example 1, an LTA-type zeolite membrane was formed; in Examples 2 and 6 and Comparative Example 2, an RHO-type zeolite membrane was formed; in Example 7, an SOD-type zeolite membrane was formed; and in Comparative Examples 3 and 4, a CHA-type zeolite membrane was formed.

TABLE 1

| | | Composition of Starting Material Solution [Molar Ratio] | | | | | | Synthesis | Synthesis | Firing | Firing |
|---|---|---|---|---|---|---|---|---|---|---|---|
| | Membrane | SiO₂/ | H₂O/ | Na₂O/ | CsOH/ | SDA/ | H₂O/ | Temperature | Time | Temperature | Time |
| | Type | Al₂O₃ | Na₂O | SiO₂ | Al₂O₃ | Al₂O₃ | Al₂O₃ | [° C.] | [h] | [° C.] | [h] |
| Example 1 | LTA | 6.5 | 477 | 0.22 | — | 1.8 | 692 | 80 | 40 | — | — |
| Example 2 | RHO | 10.0 | 278 | 0.18 | 0.4 | 1.5 | 500 | 100 | 20 | — | — |
| Example 3 | LTA | 6.5 | 690 | 0.22 | — | 1.8 | 1000 | 80 | 40 | 430 | 15 |
| Example 4 | LTA | 6.5 | 690 | 0.22 | — | 1.8 | 1000 | 80 | 40 | 400 | 15 |
| Example 5 | LTA | 10.0 | 690 | 0.15 | — | 3.0 | 1000 | 80 | 100 | — | — |
| Example 6 | RHO | 8.0 | 556 | 0.23 | 0.8 | 2.0 | 1000 | 100 | 20 | — | — |
| Example 7 | SOD | 7.3 | — | — | — | 0.2 | 207 | 180 | 10 | — | — |
| Comparative | LTA | 15.0 | 357 | 0.09 | — | 20.0 | 500 | 80 | 40 | 450 | 15 |
| Example 1 | | | | | | | | | | | |
| Comparative | RHO | 10.0 | 278 | 0.18 | 0.4 | 1.5 | 500 | 100 | 20 | 450 | 20 |
| Example 2 | | | | | | | | | | | |
| Comparative | CHA | 200.0 | 3200 | 0.03 | — | 10.0 | 16000 | 160 | 20 | — | — |
| Example 3 | | | | | | | | | | | |
| Comparative | CHA | 200.0 | 3200 | 0.03 | — | 10.0 | 16000 | 160 | 20 | 400 | 40 |
| Example 4 | | | | | | | | | | | |

### Preparation of LTA-Type Zeolite Membrane

A starting material solution was obtained by mixing sodium aluminate (manufactured by Sigma-Aldrich) serving as an Al source, colloidal silica (LUDOX AS-40 manufactured by Sigma-Aldrich) serving as an Si source, sodium hydroxide (manufactured by Sigma-Aldrich) serving as an Na source, and a tetramethylammonium hydroxide solution (manufactured by FUJIFILM Wako Pure Chemical Corporation) serving as an SDA with deionized water. If all of the Al, Si, and Na sources are assumed to exist as oxides, the SiO₂/Al₂O₃ molar ratio, the H₂O/Na₂O molar ratio, the Na₂O/SiO₂ molar ratio, the SDA/Al₂O₃ molar ratio, and the H₂O/Al₂O₃ molar ratio in the starting material solution were as shown in Table 1.

A porous alumina support having a monolith shape and having cells (through holes) in which seed crystals of a separately prepared LTA-type zeolite were deposited was immersed in the starting material solution, and the resultant starting material solution was subjected to heating (hydrothermal synthesis). The synthesis temperature and the synthesis time at the time of hydrothermal synthesis were as shown in Table 1. Accordingly, an LTA-type zeolite membrane was formed on the support. After the hydrothermal synthesis, the support and the zeolite membrane were cleaned enough with deionized water and then dried at 80° C. Thereafter, in Example 3, the LTA-type zeolite membrane was subjected to heat treatment at 430° C. for 15 hours; in Example 4, the LTA-type zeolite membrane was subjected to heat treatment at 400° C. for 15 hours; and in Comparative Example 1, the LTA-type zeolite membrane was subjected to heat treatment at 450° C. for 15 hours. Accordingly, part or all of the SDA contained in the LTA-type zeolite membrane was removed by combustion. In Examples 1 and 5, the SDA was not removed by combustion. Through the above-described processing, the zeolite membrane complexes according to Examples 1 and 3 to 5 and Comparative Example 1, each including the LTA-type zeolite membrane, were obtained.

### Preparation of RHO-Type Zeolite Membrane

A starting material solution was obtained by mixing aluminum hydroxide (manufactured by Sigma-Aldrich) serving as an Al source, colloidal silica (SNOWTEX-S manufactured by Nissan Chemical Corporation) serving as an Si source, sodium hydroxide (manufactured by Sigma-Aldrich) serving as an Na source, cesium hydroxide (manufactured by Sigma-Aldrich) serving as a Cs source, and 18-crown-6 (manufactured by Tokyo Chemical Industry Co., Ltd.) serving as an SDA with deionized water. The SiO₂/Al₂O₃ molar ratio, the H₂O/Na₂O molar ratio, the Na₂O/SiO₂ molar ratio, the CsOH/Al₂O₃ molar ratio, the SDA/Al₂O₃ molar ratio, and the H₂O/Al₂O₃ molar ratio in the starting material solution were as shown in Table 1.

A porous alumina support having a monolith shape and having cells in which seed crystals of a separately prepared RHO-type zeolite were deposited was immersed in the starting material solution, and the resultant starting material solution was subjected to heating (hydrothermal synthesis). The synthesis temperature and the synthesis time at the time of hydrothermal synthesis were as shown in Table 1. Accordingly, an RHO-type zeolite membrane was formed on the support. After the hydrothermal synthesis, the support and the zeolite membrane were cleaned enough with deionized water and then dried at 80° C. Thereafter, in Comparative Example 2, the RHO-type zeolite membrane was subjected to heat treatment at 450° C. for 20 hours so as to remove the SDA by combustion. In Examples 2 and 6, the SDA was not removed by combustion. Through the above-described processing, the zeolite membrane complexes according to Examples 2 and 6 and Comparative Example 2, each including the RHO-type zeolite membrane, were obtained.

### Preparation of SOD-Type Zeolite Membrane

A starting material solution was obtained by mixing aluminum isopropoxide (manufactured by KANTO CHEMICAL Co. Ltd.) serving as an Al source, tetraethoxysilane (manufactured by KANTO CHEMICAL Co. Ltd.) serving as an Si source, a tetramethylammonium hydroxide solution (manufactured by FUJIFILM Wako Pure Chemical Corporation) serving as an SDA with deionized water. The SiO₂/Al₂O₃ molar ratio, the SDA/Al₂O₃ molar ratio, and the H₂O/Al₂O₃ molar ratio in the starting material solution were as shown in Table 1.

A porous alumina support having a monolith shape and having cells in which seed crystals of a separately prepared SOD-type zeolite were deposited was immersed in the starting material solution, and the resulting starting material solution was subjected to heating (hydrothermal synthesis). The synthesis temperature and the synthesis time at the time of hydrothermal synthesis were as shown in Table 1. Accordingly, an SOD-type zeolite membrane was formed on the support. After the hydrothermal synthesis, the support and the zeolite membrane were cleaned enough with deionized water and then dried at 80° C. Through the above-described processing, the zeolite membrane complex according to Example 7, which includes the SOD-type zeolite membrane, was obtained. Note that the SDA was not removed by combustion.

### Preparation of CHA-Type Zeolite Membrane

A starting material solution was obtained by mixing aluminum hydroxide (manufactured by Sigma-Aldrich) serving as an Al source, colloidal silica (SNOWTEX-S manufactured by Nissan Chemical Corporation) serving as an Si source, sodium hydroxide (manufactured by Sigma-Aldrich) serving as an Na source, and a trimethyladamantyl ammonium hydroxide solution (manufactured by SACHEM, Inc.) serving as an SDA with deionized water. The SiO₂/Al₂O₃ molar ratio, the H₂O/Na₂O molar ratio, Na₂O/SiO₂ molar ratio, the SDA/Al₂O₃ molar ratio, and the H₂O/Al₂O₃ molar ratio in the starting material solution were as shown in Table 1.

A porous alumina support having a monolith shape and having cells in which seed crystals of a separately prepared CHA-type zeolite were deposited was immersed in the starting material solution, and the resultant starting material solution was subjected to heating (hydrothermal synthesis). The synthesis temperature and the synthesis time at the time of hydrothermal synthesis were as shown in Table 1. Accordingly, a CHA-type zeolite membrane was formed on the support. After the hydrothermal synthesis, the support and the zeolite membrane were cleaned enough with deionized water and then dried at 80° C. Thereafter, in Comparative Example 4, the CHA-type zeolite membrane was subjected to heat treatment at 400° C. for 40 hours so as to remove the SDA by combustion. In Comparative Example 3, the SDA was not removed by combustion. Through the above-described processing, the zeolite membrane complexes according to Comparative Examples 3 and 4, each including the CHA-type zeolite membrane, were obtained.

Table 2 shows the composition of the membrane, water/ethanol separation performance, and hydrothermal endurance of the zeolite membranes according to Examples 1 to 7 and Comparative Examples 1 to 4.

| | | | | | Water/Ethanol Separation | | |
|---|---|---|---|---|---|---|---|
| | | | | | Performance | | Hydrothermal Endurance |
| | | | | | Total | | Separation Factor after |
| | | Membrane Composition | | | Permeation | Separation | Hot Water Immersion/ |
| | Membrane | C/(Al + Si) | Si/Al | | Flux | Factor | Separation Factor before |
| | Type | [—] | [—] | N Content | [kg/m²h] | [—] | Hot Water Immersion |
| Example 1 | LTA | 1.60 | 2.8 | ∘ | ≥2.0 | ≥2000 | 0.99 |
| Example 2 | RHO | 2.13 | 5.2 | x | ≥1.5 | ≥2000 | 0.85 |
| Example 3 | LTA | 0.11 | 2.8 | ∘ | ≥2.0 | ≥1000 | 0.85 |
| Example 4 | LTA | 0.32 | 2.8 | ∘ | ≥2.0 | ≥1000 | 0.95 |
| Example 5 | LTA | 2.80 | 1.6 | ∘ | ≥2.0 | ≥2000 | 0.98 |
| Example 6 | RHO | 1.60 | 3.3 | x | ≥1.0 | ≥1000 | 0.78 |
| Example 7 | SOD | 0.67 | 5.0 | ∘ | ≥1.0 | ≥2000 | 0.95 |
| Comparative | LTA | 0.00 | 2.8 | x | ≥2.0 | ≥2000 | 0.30 |
| Example 1 | | | | | | | |
| Comparative | RHO | 0.00 | 5.2 | x | ≥1.5 | ≥2000 | 0.20 |
| Example 2 | | | | | | | |
| Comparative | CHA | 3.95 | 15.9 | ∘ | No separation | | — |
| Example 3 | | | | | | | |
| Comparative | CHA | 0.00 | 15.9 | x | ≥1.0 | 420 | — |
| Example 4 | | | | | | | |

### Measurements of Membrane Composition

The C/(Al+Si) molar ratio, the Si/Al molar ratio, and the presence or absence of N content (respectively given as “C/(Al+Si),” “Si/Al,” and “N Content” in Table 2) in a section of each zeolite membrane were measured by scanning electron microscope-energy dispersed X-ray spectroscopy (SEM-EDX). The acceleration voltage was set to 15 kV. As to the presence or absence of N content, the zeolite membrane was determined to content N when the molar ratio of nitrogen to the sum of aluminum and silicon (i.e., N/(Al+Si) molar ratio) was higher than or equal to 0.03. In Table 2, the presence of N content in the zeolite membrane was indicated by a white circle, and the absence of N content in the zeolite membrane was indicated by a cross. In the zeolite membranes according to Examples 1 to 7 and Comparative Example 3, the C/(Al+Si) molar ratios were all higher than or equal to 0.1.

### Water/Ethanol Separation Test

The water/ethanol separation test was conducted by pervaporation, using the above-described separation apparatus 2. In the separation apparatus 2, the zeolite membrane complex was placed in the housing 22. In the test, a mixed solution having a temperature of 60° C. and containing 50 mass % of water and 50 mass % of ethanol was supplied from the supplier 26 via the supply port 221 to the housing 22 under atmospheric pressure. The pressure at the second exhaust port 223 on the permeate side of the zeolite membrane complex was reduced to −94.66 kPaG (approximately 50 Torr). The gas that had permeated the zeolite membrane and had been derived from the outer surface of the support 11 was cooled and collected as a liquid by the second collector 28. The amount of fluid that had permeated a unit area of the membrane per unit time, i.e., a total permeation flux (kg/m² h), was calculated from the mass of the liquid collected by the second collector 28. Moreover, the concentrations (mass %) of water and ethanol in the liquid were measured, and the water concentration/the ethanol concentration was acquired as a separation factor.

In Examples 1 to 7 and Comparative Examples 1 and 2, the total permeation fluxes were higher than or equal to 1.0 kg/m² h, and the separation factors were greater than or equal to 1000. With respect to the CHA-type zeolite membrane, in Comparative Example 3 in which the SDA was not removed, water did not permeate the membrane (i.e., the mixed solution was not separated), and in Comparative Example 4 in which the SDA was removed by combustion, the separation factor was 420 and considerably small.

### Evaluation of Hydrothermal Endurance

In the evaluation of the hydrothermal endurance, the zeolite membrane complex was immersed in deionized water having a temperature of 100° C. for 6 hours and then dried at 80° C. for 12 hours or more. Thereafter, the “water/ethanol separation test” described above was conducted again to measure the separation factor, and the ratio of the separation factor after immersion to the separation factor before immersion (“Separation Factor after Hot Water Immersion/Separation Factor before Hot Water Immersion” in Table 2) was defined as an indicator of the hydrothermal endurance. In Comparative Examples 3 and 4, the evaluation of the hydrothermal endurance was not conducted.

In Comparative Examples 1 and 2 in which the detected C was ultimately close to zero and the C/(Al+Si) molar ratios was zero, the values of the hydrothermal endurance (the ratio of the separation factor after immersion to the separation factor before immersion) were less than or equal to 0.3. In contrast, in Examples 1 to 7 in which the C/(Al+Si) molar ratios were higher than or equal to 0.1, the values of the hydrothermal endurance were greater than or equal to 0.7 and considerably high. When comparison is made among Examples 1, 3, and 4 whose zeolite types and Si/Al molar ratios were the same, the value of the hydrothermal endurance increased with increasing C/(A1+Si) molar ratio. Specifically, in Examples 1 and 4 in which the C/(Al+Si) molar ratios were higher than or equal to 0.3, the values of the hydrothermal endurance were greater than or equal to 0.95.

As described thus far, the zeolite membrane complex 1 includes the porous support 11 and the zeolite membrane 12 formed on the support 11 and containing aluminum, silicon, and carbon. Since the zeolite membrane 12 has a stabilized crystal structure due to the presence of the SDA, which is an organic compound (a substance containing carbon), in the pores, the zeolite membrane 12 can have more improved hydrothermal endurance than zeolite membranes in which there is no SDA existing in the pores. In the zeolite membrane complex 1, when a mixed solution having a temperature of 60° C. and containing 50 mass % of water and 50 mass % of ethanol is supplied with a permeate pressure of −94.66 kPaG, the total permeation flux is higher than or equal to 1.0 kg/m² h, and the separation factor of water to ethanol is greater than or equal to 1000. In this way, the zeolite membrane complex 1 can achieve high water separation performance even if the SDA exists in the pores.

The degree of the amount of the SDA contained in the zeolite membrane 12 can be represented by the molar ratio of carbon to the sum of aluminum and silicon in the zeolite membrane 12. In the zeolite membrane 12, the molar ratio of carbon to the sum of aluminum and silicon is higher than or equal to 0.1, and may preferably be higher than or equal to 0.3. This allows the SDA to exist in most of the pores in the zeolite membrane 12 and to more reliably improve hydrothermal endurance. The molar ratio of carbon to the sum of aluminum and silicon may, for example, be lower than or equal to 5.0, preferably lower than or equal to 4.0, and more preferably lower than or equal to 3.0. Preferably, the zeolite membrane 12 may further contain nitrogen. This zeolite membrane complex 1 can more reliably achieve improved hydrothermal endurance due to the presence of the SDA containing nitrogen in the pores of the zeolite membrane 12.

The silicon/aluminum molar ratio in the zeolite membrane 12 may preferably be higher than or equal to 1 and lower than or equal to 10 and more preferably higher than or equal to 1 and lower than or equal to 6. This increases the affinity for water of the zeolite membrane 12 and further improves water separation performance. Ordinarily, a zeolite membrane that has a low silicon/aluminum molar ratio has low durability, but the zeolite membrane 12 containing the SDA can achieve high hydrothermal endurance even if the silicon/aluminum molar ratio is low.

Preferably, the zeolite membrane 12 may contain an AEI-, AFT-, AFX-, ANA-, CHA-, ETL-, ERI-, FER-, KFI-, LTA-, MER-, RHO-, SOD-, MOR-, FAU-, BEA-, or HEU-type zeolite. More preferably, the zeolite membrane 12 may contain an AEI-, AFT-, AFX-, ANA-, CHA-, ETL-, ERI-, KFI-, LTA-, MER-, RHO-, or SOD-type zeolite. This zeolite membrane can more reliably achieve the zeolite membrane complex 1 with high water separation performance and improved hydrothermal endurance. It is of course possible for the zeolite membrane 12 to contain any other type of zeolite.

The zeolite membrane complex 1 and the membrane reactor described above may be modified in various ways.

Depending on the hydrothermal endurance required for the zeolite membrane complex 1, the molar ratio of carbon to the sum of aluminum and silicon in the zeolite membrane 12 may be higher than 3.0. Depending on the strength or water separation performance required for the zeolite membrane complex 1, the silicon/aluminum molar ratio in the zeolite membrane 12 may be lower than 1, or may be higher than 6.

In the production of the zeolite membrane 12, it is possible to use an SDA that does not contain nitrogen, and in this case, the zeolite membrane 12 does not need to contain nitrogen.

The zeolite membrane complex 1 may further include, in addition to the support 11 and the zeolite membrane 12, a functional membrane or a protection membrane that is laminated on the zeolite membrane 12. Such a functional or protection membrane may be an inorganic membrane such as a zeolite membrane, a silica membrane, or a carbon membrane, or may be an organic membrane such as a polyimide membrane or a silicone membrane. Moreover, a substance that can easily adsorb water may be added to the functional or protection membrane laminated on the zeolite membrane 12.

In the separation apparatus 2, the membrane reactor, and the separation method, the separation of a mixture of substances may be conducted by a different method such as vapor permeation, reverse osmosis, or gas permeation other than pervaporation described above.

In the separation apparatus 2, the membrane reactor, and the separation method, a substance other than those exemplified in the above description may be separated from a mixture of substances.

The configurations of the above-described preferred embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The zeolite membrane complex according to the present invention is applicable as, for example, a dehydrating membrane and is also applicable as, for example, a separation membrane for separating various substances other than water or as an adsorption membrane for adsorbing various substances in various fields using zeolites.

REFERENCE SIGNS LIST

| | |
|---|---|
| 1 | zeolite membrane complex |
| 11 | support |
| 12 | zeolite membrane |

1. A zeolite membrane complex comprising:
a porous support; and
a zeolite membrane formed on said support and containing aluminum, silicon, and carbon,
wherein in said zeolite membrane, a molar ratio of carbon to a sum of aluminum and silicon is higher than or equal to 0.1, and
when a mixed solution having a temperature of 60° C. and containing 50 mass % of water and 50 mass % of ethanol is supplied with a permeate pressure of −94.66 kPaG, a total permeation flux is higher than or equal to 1.0 kg/m² h, and a separation factor of water to ethanol is greater than or equal to 1000.

2. The zeolite membrane complex according to claim 1, wherein
in said zeolite membrane, the molar ratio of carbon to the sum of aluminum and silicon is higher than or equal to 0.1 and lower than or equal to 3.0.

3. The zeolite membrane complex according to claim 1, wherein
in said zeolite membrane, the molar ratio of carbon to the sum of aluminum and silicon is higher than or equal to 0.3 and lower than or equal to 3.0.

4. The zeolite membrane complex according to claim 1, wherein
said zeolite membrane further contains nitrogen.

5. The zeolite membrane complex according to claim 1, wherein
said zeolite membrane has a silicon/aluminum molar ratio of higher than or equal to 1 and lower than or equal to 6.

6. The zeolite membrane complex according to claim 1, wherein
said zeolite membrane contains an AEI-, AFT-, AFX-, ANA-, CHA-, ETL-, ERI-, FER-, KFI-, LTA-, MER-, RHO-, SOD-, MOR-, FAU-, BEA-, or HEU-type zeolite.

7. The zeolite membrane complex according to claim 1, wherein
said zeolite membrane contains an AEI-, AFT-, AFX-, ANA-, CHA-, ETL-, ERI-, KFI-, LTA-, MER-, RHO-, or SOD-type zeolite.

8. A membrane reactor comprising:
the zeolite membrane complex according to claim 1;
a catalyst that accelerates a chemical reaction of a starting material;
a reactor in which said zeolite membrane complex and said catalyst are placed; and
a supplier that supplies said starting material to said reactor,
wherein said zeolite membrane complex separates a high-permeability substance having high permeability in a mixture of substances from other substances by allowing said high-permeability substance to permeate said zeolite membrane complex, the mixture of substances containing a product substance generated by a chemical reaction of said starting material in the presence of said catalyst.
